(19) United States
(12) Patent Application Publication
(10) Pub. No.: US 2016/0374350 A1
(43) Pub. Date: Dec. 29, 2016

(54) METHOD OF TREATING BED BUG INFESTATION AND PREVENTING TRANSMISSION THEREOF

(71) Applicant: Anthony C. Watson, Dayton, OH (US)

(72) Inventor: Anthony C. Watson, Dayton, OH (US)

(21) Appl. No.: 14/753,825

(22) Filed: Jun. 29, 2015

(51) Int. Cl. A01N 65/00; A01M 29/12; A01N 65/44; A01N 65/36; A01N 65/22; A01N 65/26; A01M 7/00; A01M 1/20

(52) U.S. Cl. CPC A01N 65/00; A01M 7/0025; A01M 29/12; A01M 1/2022; A01N 65/36; A01N 65/22; A01N 65/26; A01N 65/44

(57) ABSTRACT

A composition for control of bed bugs and pests includes alcohol or distilled water in an amount of about 80% to 95%, and an effective amount of about 3% to 15% of cedar oil or neem oil, and up to about 5% of one of citrus sinensis, lavender oil and lemon grass oil which formulation is effective for kill and/or control of a bed bug and pest and/or a bed bug and pest egg. A method of treatment uses the composition.

### FIELD OF THE INVENTION

This concerns a composition and method to control insect pests, notably bedbugs.

### BACKGROUND TO THE INVENTION

Bedbugs have reappeared after the cessation of certain pesticides. Residential, hotels and motels can have a significant infestation issues. The ingress and egress into a place of infestation and the ineffectiveness or inadequacy of compositions or methods for treatment contribute to this.

It is desirable to provide generally safe and effective ways and means to control bedbugs. The instant invention aims to do this.

### SUMMARY OF THE INVENTION

It is an object to prevent spreading of bed bugs.

It is another object to treat bed bug infested areas.

Accordingly, one aspect of the invention is a composition for control of insect pests, which comprises one of an alcohol and distilled water in an amount of about 80% to 95%, and an effective amount of about 3% to 15% of cedar oil or neem oil, and up to about 5% of one of citrus sinensis, lavender oil and lemon grass oil (citronella) which formulation is effective for kill and/or control of a bed bug (and other hatched insect pest) and/or a bed bug egg (or insect pest egg).

Another aspect of the invention is a method for kill or control of bed buds or pests, comprises the steps of providing the aforesaid composition; and applying the composition on one's garments prior to entering an infested or potential infested premises to contact a bed bug and/or bed bug egg in an amount effective to kill or control the same. The method also includes inspection of premises that may contain the infestation, and, if necessary, for kill or control of the same, which may include by employment of the method for control of the bed bug. Further, upon exit of the premises, applying the composition on one's garments to contact a bed bug and/or bed bug egg in an amount effective to kill or control the same.

A generally safe and effective composition is provided to ameliorate, if not completely control, insect pests, especially bedbugs. The method and protocol can be employed by persons entering at homes, motels, hotels and businesses. The invention is economical and simple to make and use. Many further advantages attend the invention.

### BRIEF DESCRIPTION OF THE DRAWINGS

FIG. 1 is a flow chart diagram of the invention.

### DETAILED DESCRIPTION OF THE INVENTION

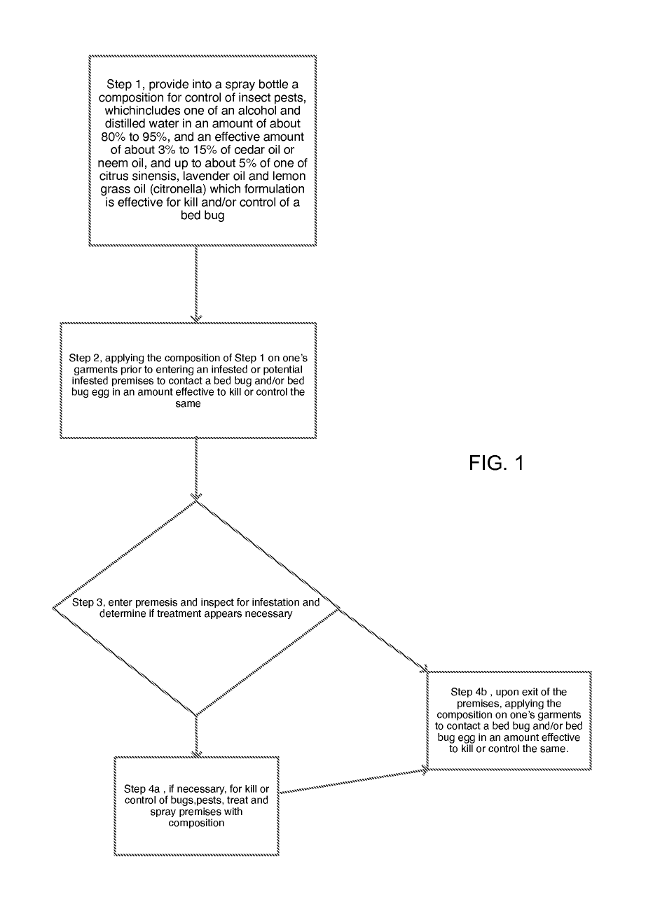

The invention can be further understood by its details hereinafter. A method of use of the invention is provided in FIG. 1. The following detail is to be taken in an illustrative and not necessarily limiting sense.

The invention employs one of an alcohol and distilled water in an amount of about 80% to 95%, and an effective amount of about 3% to 15% of cedar oil or neem oil, and up to about 5% of a suitable fragrance such as one of citrus sinensis, lavender oil and lemon grass oil (citronella) can be provided which formulation is effective for kill and/or control of a bed bug (and other hatched insect pest) and/or a bed bug egg (or insect pest egg).

One or more additional ingredient(s) may be employed, which may include wetting and/or other agent(s) such as what may be considered to be surface tension lowering agent(s), cleaner(s), surfactant(s), defoaming agent(s), dispersing agent(s), thickening agent(s), preservative(s), which may be biocidal, fragrance(s) and so forth and the like.

Thus may be employed, rubbing alcohol and water in 10-95%. These act as a diluent. For example, water and/or alcohol or other diluent may be employed to make a liquid composition.

An exemplary compositions with percentages by weight, which may be considered to be exact or approximate are as follow:

Formulation 1. cedar oil 5-20% lavender oil up to 5% citrus sinensis up to 5% which can be added within a diluent making up the balance, e.g., water or alcohol.

Formulation 2. neem oil 5-20% lavender oil up to 5% citrus sinensis up to 5% which can be added within a diluent making up the balance, e.g., water or alcohol.

Formulation 3. cedar oil 5-20% lemon grass oil (citronella) <1% lavender oil up to 5% citrus sinensis up to 5% which can be added within a diluent making up the balance, e.g., water or alcohol.

Formulation 4. neem oil 5-20% lemon grass oil (citronella) <1% lavender oil up to 5% citrus sinensis up to 5% which can be added within a diluent making up the balance, e.g., water or alcohol.

The ingredient(s) together yield 100%. Thus, corresponding amounts based on a predetermined ingredient amount in the above general formulations may be determined. Use of the composition includes applying the composition in the following manner.

A method for kill or control of a bed bugs or pests includes the steps of providing one of the aforesaid compositions; and applying the composition on one's garments prior to entering an infested or potential infested premises to contact a bed bug and/or bed bug egg in an amount effective to kill or control the same. The method also includes inspection of premises that may contain the infestation, and, if necessary, for kill or control of the same, which may include by employment of the method for control of the bed bug. The application of the compositions may be made directly to the insect bed bug or pest and/or bed bug or insect pest egg, or it may be made indirectly such as by applying the composition to bedding, which then contacts the bed bug or insect pest and/or bed bug or insect pest egg. The composition may be sprayed on materials such as the mattresses sofa, chairs, carpet, walls, clothing and other items in the infested area.

The composition is a liquid suitable for spraying in a spray bottle which is preferable shaken before use. The spray bottle may be held a suitable distance from the material to be sprayed easily to achieve suitable saturation. Inside the premises, all bedding should be placed in a plastic bag and treated and then contained to avoid any contact with the infested environment.

The entire bed and contacting structure should be treated. Additionally, wall hangings and curtains should likewise be treated and contained in bags. Several hours after treatment, inspect premises for any remaining infestation treatment. Upon exit of the premises, the composition is applied on one's garments to contact a bed bug and/or bed bug egg in an amount effective to kill or control the same.

A generally safe and effective composition is provided to ameliorate, if not completely control, insect pests, especially bedbugs. The method can be employed by persons entering at homes, motels, hotels and businesses.

The instant invention is provides an improved treatment and method for addressing bed bugs and like pests. The embodiments described are intended to be illustrative and the claims appended hereto are not intended to be limiting, but modifications, improvements and derivations are to be within the claims which follow.

What is claimed is:

1. A composition for control of bed bugs and pests, which comprises: one of an alcohol and distilled water in an amount of about 80% to 95%, and an effective amount of about 3% to 15% of one of cedar oil and neem oil, and up to about 5% of one of citrus sinensis, lavender oil and lemon grass oil which formulation is effective for kill and/or control of a bed bug and pest and/or a bed bug and pest egg.

2. The composition of claim 1, which is further characterized to include less than 1% lemon grass oil.

3. A method for kill or control of bed bugs and pests, comprises the steps of: providing in a spray bottle a composition having one of an alcohol and distilled water in an amount of about 80% to 95%, and an effective amount of about 3% to 15% of one of cedar oil and neem oil, and up to about 5% of one of citrus sinensis, lavender oil and lemon grass oil which formulation is effective for kill and/or control of a bed bug and/or a bed bug egg; and upon exit of said premises, applying said composition on one's garments to contact a bed bug and/or bed bug egg in an amount effective to kill or control the same.

4. The method for kill or control of bed bugs and pests of claim 3, which further comprises the step of applying said composition on one's garments prior to entering an infested or potential infested premises to contact a bed bug and/or bed bug egg in an amount effective to kill or control the same.

5. The method for kill or control of bed bugs and pests of claim 3, which further comprises the step of inspecting of premises that may contain the infestation for kill and control of the bed bug and/or bed bug egg and upon infestation determination, employment of spraying and treating said premises with said composition to control and kill bed bug and/or bed bug egg.

6. A method for kill or control of bed bugs and pests, comprises the steps of: providing in a spray bottle a composition having one of an alcohol and distilled water in an amount of about 80% to 95%, and an effective amount of about 3% to 15% of one of cedar oil and neem oil, and up to about 5% of one of citrus sinensis, lavender oil and lemon grass oil which formulation is effective for kill and/or control of a bed bug and/or a bed bug egg; and prior to entry of said premises, applying said composition on one's garments to contact a bed bug and/or bed bug egg in an amount effective to kill or control the same.

7. The method for kill or control of bed bugs and pests of claim 6, which further comprises the step of inspecting of premises that may contain the infestation for kill and control of the bed bug and/or bed bug egg and upon infestation determination, employment of spraying and treating said premises with said composition to control and kill bed bug and/or bed bug egg.

8. The method for kill or control of bed bugs and pests of claim 7, which further comprises the step of applying said composition on one's garments upon exiting an infested or potential infested premises to contact a bed bug and/or bed bug egg in an amount effective to kill or control the same.
